(19) United States
(12) Patent Application Publication
(10) Pub. No.: US 2008/0273432 A1
(43) Pub. Date: Nov. 6, 2008

(54) PROCESSING METHOD OF OPTICAL DISC RECORDING/PLAYBACK SIGNAL, OPTICAL DISC RECORDING/PLAYBACK DEVICE AND PROGRAM

(75) Inventors: Katsuhiro Oyama, Gunma (JP); Hiroya Kakimoto, Gunma (JP); Fuyuki Miyazawa, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd, Tokyo (JP)

(21) Appl. No.: 12/107,647

(22) Filed: Apr. 22, 2008

(30) Foreign Application Priority Data
Apr. 23, 2007 (JP) 2007-112581

(51) Int. Cl. G11B 5/00; G11B 7/00

(52) U.S. Cl. 369/47.53; 369/53.11

(57) ABSTRACT

A processing method of an optical disc recording/playback signal includes: measuring a length of a first mark of a predetermined coding length which appears immediately following a shortest space recorded on the optical disc; measuring a length of a second mark which appears immediately following a longest space recorded on the optical disc and which has the same coding length as the first mark; and calculating a heat interference amount based on a difference of the measured length of the first mark and the measured length of the second mark. The method may further include specifying a laser power at a time of forming a space or a cooling pulse width, according to the heat interference amount.

### BACKGROUND OF THE INVENTION

1. Field of the Invention

The present invention relates to a technique to evaluate and determine conditions for recording onto an optical disc.

2. Description of the Related Art

Data recording onto an optical disk is performed by controlling the intensity and irradiating timing of a laser beam, and by forming marks and spaces alternately on an optical disc. With this data recording, irregularity in the spot diameters of the laser beam on the optical disc (hereafter, simply called “spot diameter”) is induced by error occurring in manufacturing, such as error in thickness of the optical disc or warping thereof and manufacturing error such as beam divergence angle of a pickup unit in an optical disc recording/playback device, whereby many problems have been occurring with recording quality.

For example, Japanese Unexamined Patent Application Publication No. 6-150322 discloses an optimal recording power control method (hereafter called “OPC” as an abbreviation of Optimum Power Control) wherein, prior to recording data in a data region of an optical disc, the laser beam intensity serving as recording power at the time of forming a mark is changed in a test region to perform test recording, thereby improving recording quality based on varied spot diameters by optimizing the laser beam intensity. However, consideration has not been given to laser power or cooling pulse width at the time of forming spaces.

Also, Japanese Unexamined Patent Application Publication No. 7-129959 discloses a technique wherein, in the case of recording data as Pulse Width Modulation (hereafter called “PWM”) on a rewritable optical disc, heat interference between marks and peak shifts at time of playback are compensated at time of recording, thereby improving the playback error rate and achieving high-density recording. Specifically, this describes a configuration wherein a signal equivalent to a PWM recording mark becomes signals resolved into a fixed width starting edge portion, a burst-shape intermediate portion, and a fixed width ending edge portion with a starting edge pulse generating circuit, a burst gate generating circuit, and an ending pulse generating circuit, thereby recording by switching the laser output of two values at a high speed. The positions of the starting edge portion and ending edge portion of the mark with this configuration are detected by the mark/space length detecting circuit when the mark length is short and the space length before and after the mark is short. A position at which to record a long mark and space can be changed, enabling compensation of heat interference or peak shifts occurring in the playback frequency features at the time of recording. However, manufacturing error such as varied spot diameters from the pickup unit is not taken into consideration, so heat interference may occur from the spot variances and deteriorate recording quality, but this cannot be handled.

### SUMMARY OF THE INVENTION

Accordingly, it is an object of the present invention to provide a technique to evaluate heat interference which occurs with variances in spot diameters from error occurring at time of manufacturing or the like.

Another object of the present invention is to provide a technique to control a system signal to perform recording or playback to improve recording quality based on evaluation of the heat interference.

An optical disc recording/playback processing method relating to a first aspect of the present invention includes: a measuring step for measuring the length of a first mark of a predetermined coding length which appears immediately following a shortest space recorded on the optical disc and the length of a second mark which appears immediately following a longest space recorded on the optical disc and which has the same coding length as the first mark; and a heat interference amount computing step to compute the heat interference amount based on the difference of the length of the first mark and the length of the second mark measured in the measuring step. Thus the heat interference amount can be readily evaluated by computing the heat interference amount based on the first and second values.

Also, the method may further include a step to specify the spot diameter of the laser beam irradiating on the optical disc with the heat interference amount computed in the heat interference amount computing step, based on data wherein the relation between the spot diameter of the laser irradiating the optical disc and the heat interference amount is measured beforehand. For example, if the relation between the heat interference amount and spot diameter is obtained beforehand, the spot diameter can be controlled immediately from the heat interference amount.

Further, the method may further include: a step for changing data recording conditions to perform the measuring step and the heat interference amount computing step; a step for specifying a data recording condition wherein the heat interference amount computed in the heat interference amount computing step is minimal; and a step for setting the specified data recording conditions. Thus, data recording conditions appropriate to the heat interference can be applied.

Also, the method may further include a step to determine whether the heat interference amount computed in the heat interference amount computing step is appropriate. For example, the normal optimal value for the first value minus second value which is the optimal value of the heat interference amount can be obtained as 0, and by comparing the computed heat interference amount thereto, determination can be made as to whether the value is appropriate or not.

Further, the method may further include a step to specify the optimal laser power at the time of forming a space with the heat interference amount computed in the heat interference amount computing step, based on data wherein the relation between the optimal laser power at the time of forming a space and the heat interference amount is measured beforehand. If a relation such as that described above is specified beforehand, the optimal laser power at the time of forming a space may be specified.

Also, the method may further include a step to specify the optimal cooling pulse width with the heat interference amount computed in the heat interference amount computing step, based on data wherein the relation between the optimal cooling pulse width and the heat interference amount is measured beforehand.

Also, the method may further include a step to specify optimal laser power at the time of forming a space or the optimal cooling pulse width with the heat interference amount computed in the heat interference computing step, based on data wherein the relation between a spot diameter and the optimal laser power at the time of forming a space or the optimal cooling pulse width and the heat interference amount is measured beforehand.

Further, there may be cases wherein the data recording condition described above is the laser power at the time of forming a space or the cooling pulse width.

An optical disc recording/playback device relating to a second aspect of the present invention includes: a measuring unit configured to measure the length of a first mark of a predetermined coding length which appears immediately following a shortest space recorded on the optical disc and the length of a second mark which appears immediately following a longest space recorded on the optical disc and which has the same coding length of the first mark; and a heat interference amount computing unit configured to compute the heat interference amount based on the difference of the length as the first mark and the length of the second mark measured in the measuring unit. The first embodiment of the present invention is applicable to the second embodiment thereof.

A program to cause a processor to execute the processing method for an optical disc recording/playback signal according to the present invention can be created, with such program being stored in a storage medium or storage device such as a flexible disk, optical disc such as a CD-ROM, magneto-optical disk, semiconductor memory, and hard disk, or a non-volatile memory of a processor. Also, the processing method may be distributed via a network with a digital signal. Note that data during processing is temporarily stored in a storage device such as the memory of a processor.

According to the present invention, heat interference occurring from variations in the spot diameters from manufacturing error and so forth can be evaluated.

Also, according to another aspect of the present invention, a system signal to perform recording/playback to improve recording quality based on the heat interference evaluation can be controlled.

### BRIEF DESCRIPTION OF THE DRAWINGS

FIGS. 1A and 1B are diagrams to describe the principles of the present invention;

FIG. 2A is a diagram illustrating various types of recording parameters in the case of a multi-pulse;

FIG. 2B is a diagram illustrating various types of recording parameters in the case of a non-multi-pulse;

FIG. 3 is a functional block diagram of a drive system according to a first through a sixth embodiment of the present invention;

FIG. 4 is a diagram illustrating the processing flow according to the first embodiment of the present invention;

FIG. 5 is a diagram to describe mark length;

FIG. 6 is a diagram illustrating an example of measurement results;

FIG. 7 is a diagram illustrating an example of the relation between heat interference amount and spot diameter;

FIG. 8 is a graph showing an example of the relation between heat interference amount and spot diameter;

FIG. 9 is a diagram illustrating an example of the relation between spot diameter and optimal laser power Ps at the time of forming a space;

FIG. 10 is a graph showing the relation between spot diameter and optimal laser power Ps at the time of forming a space;

FIG. 11 is a diagram illustrating the effect in the case that the laser power Ps at the time of forming a space is optimized;

FIG. 12 is a diagram showing processing flow according to a second embodiment of the present invention;

FIG. 13 is a diagram showing the processing flow according to a third embodiment of the present invention;

FIG. 14 is a graph showing the relation between heat interference amount and optimal cooling pulse width;

FIG. 15 is diagram showing processing flow according to a fourth embodiment of the present invention;

FIG. 16 is diagram showing processing flow according to a fifth embodiment of the present invention;

FIG. 17 is a diagram illustrating the relation between disc warping and a lens tilt angle;

FIG. 18 is a schematic diagram for describing disc warping and lens tilt angle;

FIG. 19 is a diagram showing processing flow according to a sixth embodiment of the present invention;

FIG. 20 is a diagram illustrating the relation between spot diameter and substrate thickness error;

FIG. 21 is a schematic diagram to describe the substrate thickness error of a disc and lens focus length;

FIG. 22 is a functional block diagram of a drive system according to a seventh embodiment of the present invention; and

FIG. 23 is a diagram showing a signal example with PRML.

### DESCRIPTION OF THE PREFERRED EMBODIMENTS

### Principles of the Present Invention

According to the present invention, the amount of heat interference occurring from the variances in spot diameters of the laser beams due to error during manufacturing and so forth are evaluated as follows. That is to say, as shown in FIG. 1A, a length A of a first mark of a predetermined coding length which is recorded immediately following a shortest space after a mark of a given length on an optical disc, and as shown in FIG. 1B, a length B of a mark which is recorded immediately following a longest space after a mark of the given length and which is the same coding length of the first mark, are measured, whereby the heat interference amount is specified by the difference between the length A of the first mark and the length B of the second mark. That is to say, if a laser with an appropriate spot diameter is being irradiated, there is no heat interference, and the length A of the first mark and the length B of the second mark are the same. On the other hand, in the case that the spot diameter is not appropriate for some reason (particularly in the case that the spot diameter is large), heat interference occurs, and the length A of the first mark which immediately follows the shortest space if in a normal situation becomes longer than the length B of the second mark immediately following the longest space.

Based on heat interference amount measured in such a situation or the spot diameter estimated from the heat interference amount, the laser power Ps at the time of forming a space or the cooling pulse width is adjusted in the first through fourth embodiments. Also, an example of physically adjusting a pickup unit will be described in the fifth and sixth embodiments.

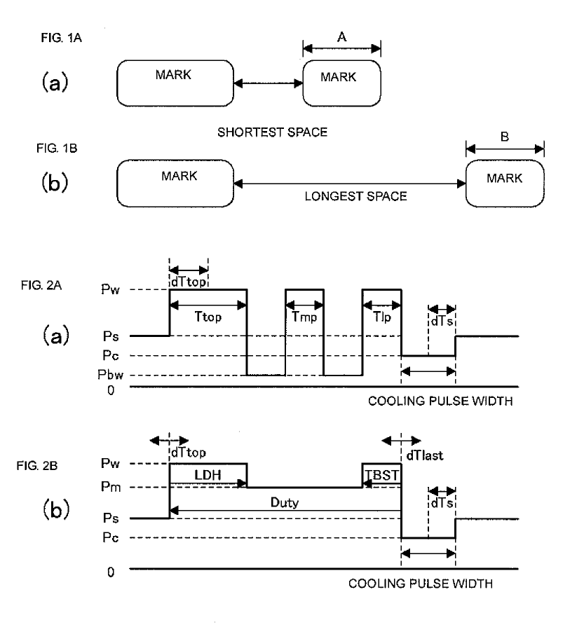

FIG. 2A shows various types of recording parameters in the case of using a multi-pulse. Parameters relating to recording power may be recording power Pw at the time of forming a mark and laser power Ps at the time of forming a space, as well as cooling power Pc at the time of cooling to suppress heat interference and bias power Pbw which is a bottom level of the pulse of the recording power Pw at the time of forming a mark. Also, parameters relating to timing may include dTtop indicating a lead pulse starting position, Ttop indicating the lead pulse width, Tmp indicating intermediate pulse width, Tlp indicating final pulse width, and dTS indicating final position of the cooling pulse. The cooling pulse width can be set by adjusting the dTs. Also, FIG. 2B shows various types of recording parameters in the case of using a non-multi-pulse. In this case also, parameters relating to recording power include recording power Pw at the time of forming a mark and laser power Ps at the time of forming a space, and other parameters may further include Pm which indicates an intermediate pulse power and Pc which indicates cooling pulse power at the time of cooling. Further, parameters relating to timing may include dTtop indicating a lead pulse starting position, LDH indicating the lead pulse width, Duty indicating a pulse width equivalent to the length of the mark formation, TBST indicating a final pulse width, dTlast indicating the final pulse ending position, and dTs indicating the ending position of the cooling pulse. In the case of a non-multi-pulse also, the cooling pulse width can be set by adjusting the dTs. Thus by using a multi-pulse, or by using a non-multi-pulse, the recording power Pw at the time of forming a mark, the laser power Ps at the time of forming a space, and the cooling pulse width need to be set appropriately.

### First Embodiment

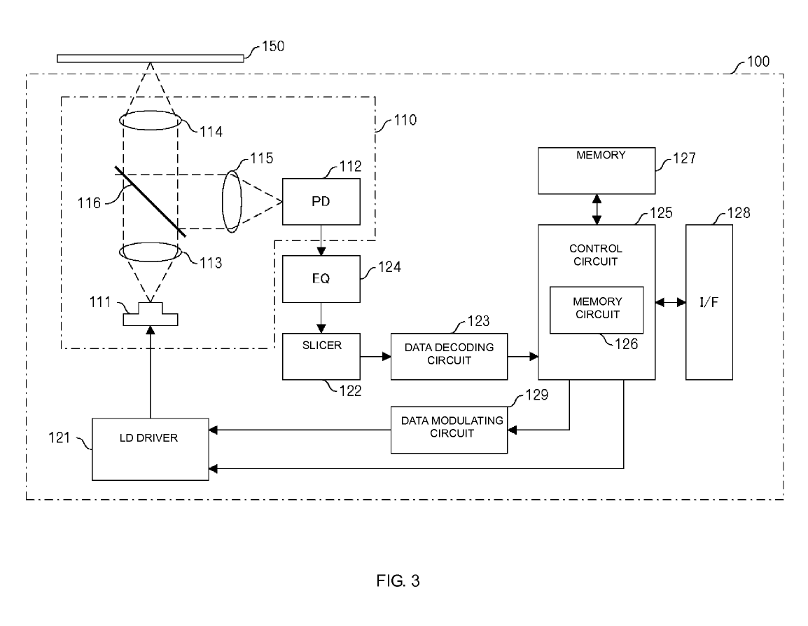

A functional block diagram of a drive system according to a first embodiment of the present invention will be described with reference to FIG. 3. The drive system relating to the embodiment of the present invention includes an optical information recording/playback device 100 and an input/output system (unshown) including a display unit such as a television receiver and an operating unit such as a remote controller and so forth.

The optical information recording/playback device 100 includes a memory 127 which stores data during processing, data of processing results, and reference data for the processing; a control circuit 125 which may comprise a memory circuit 126 wherein programs to perform processing to be described below are recorded (e.g., a control circuit in a Central Processing Unit); an interface unit (hereafter called “interface”) 128 which is an interface with the input/output system; an Equalizer (hereafter abbreviated to “EQ”) 124 which performs processing such as amplifying and decoding for the codes 2T through 1T which have been read out from an RF signal which is a playback signal; a slicer 122 for binarizing the recording mark signal, which has been amplified and compounded, at a regulated level; a data decoding circuit 123 which identifies whether there is any heat interference and enables measurement thereof a pick-up unit 110; a data modulation circuit 129 which performs predetermined modulation as to the data to be recorded which is output from the control circuit 125 and outputs this to a laser diode (hereafter abbreviated to “LD”) driver 121; the LD driver 121 which drives the LD, a servo control unit (unshown) for a rotation control unit of the optical disc 150, a motor, and the pick-up unit 110; and so forth.

Also, the pick-up unit 110 includes an objective lens 114, a beam splitter 116, a detecting lens 115, a collimating lens 113, an LD 111, and a photo-detector (hereafter abbreviated to “PD”) 112. With the pick-up unit 110, an unshown actuator operates in accordance with control of an unshown servo control unit, whereby focusing and tracking is performed.

The control circuit 125 is connected to the memory 127, interface 128, LD driver 121, data modulating circuit 129, and unshown rotation control unit and servo control unit and so forth. The LD driver 121 is connected to the data modulating circuit 129, control circuit 125, and LD 111. The control circuit 125 is also connected to the input/output system via the interface 128.

Next, an overview of the processing in the case of recording data as to the optical disc 150 will be described. First, the control circuit 125 causes the data modulating circuit 129 to perform predetermined modulating processing as to the data to be recorded on the optical disc 150, and the data modulating circuit 129 outputs the data following modulating processing to the LD driver 121. The LD driver 121 drives the LD 111 with the received data to output the laser beam according to the specified recording conditions. The laser beam is irradiated onto the disc 150 via the collimating lens 113, beam splitter 116, and objective lens 114, and alternately forms a mark and a space on the optical disc 150.

Also, an overview of the processing in the case of playing back the data recorded on the optical disc 150 will be described. The LD driver 121 drives the LD 111 to output laser beam in accordance with instructions from the control circuit 125. The laser beam is irradiated onto the disc 150 via the collimating lens 113, beam splitter 116, and objective lens 114. The reflected light from the optical disc 150 is input into the PD 112 via the objective lens 114, beam splitter 116, and detecting lens 115. The PD 112 converts the reflected light from the disc 150 into an electric signal, and outputs this to the EQ 124. The EQ 124, slicer 122, and data decoding circuit 123 and so forth perform predetermined decoding processing as to the playback signal which has been output, outputs the decoded data to a display unit of the input/output system via the control circuit 125 and interface 128 to display the playback data.

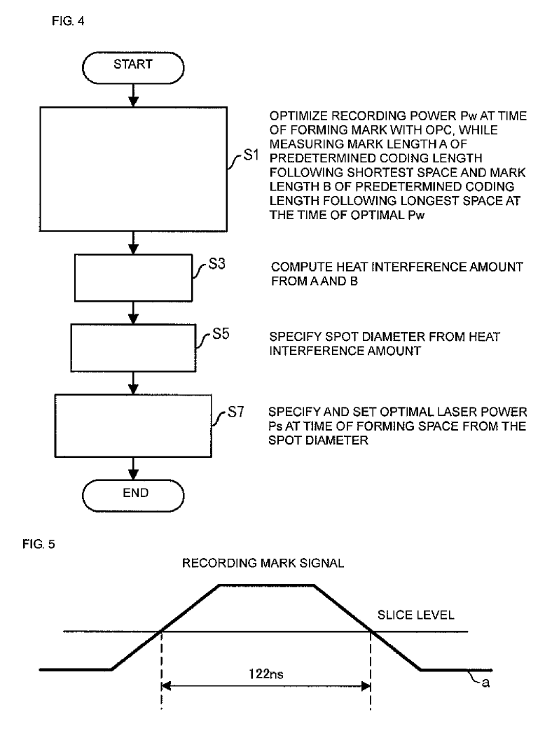

Next, the processing content according to the first embodiment will be described with reference to FIGS. 4 through 10. First, the control circuit 125 performs optimization of the recording power Pw at the time of forming a mark with the OPC, and at the same time causes the data decoding circuit 123 to measure the length A of the first mark of the predetermined coding length immediately following the shortest space when at optimal recording power at the time of forming a mark and the length B of the second mark of the predetermined coding length immediately following the longest space (step S1). Methods of OPC are widely known, so further description thereof will be omitted. When the optimal recording power Pw at the time of forming a mark with the OPC is specified, the length A of the above-mentioned first mark at the time thereof and the length B of the second mark are measured. The length A of the first mark and the length B of the second mark are measured as time or length, as shown in FIG. 5. That is to say, in FIG. 5, the horizontal axis represents time, and the vertical axis represents an amplitude level, whereby the output of the EQ 124 is expressed as the recording mark signal a in FIG. 5. With the slicer 122 the recording mark signal a is binarized with the slice level in FIG. 5, and the time serving as “1” is measured with a standard clock count, for example. In the example in FIG. 5, for example this is measured as 122 ns. Thus the length A of the first mark and the length B of the second mark may be understood as time, but length can also be computed if the beam scan speed is multiplied by the measured time. For example, if the beam scan speed is 4.92 m/s, we can see that the mark length is approximately 600 nm. The data decoding circuit 123 outputs the measurement results to the control circuit 125. Note that an arrangement may be made wherein, in step S1, the data decoding circuit 123 outputs the measured time to the control circuit 125, whereby the control circuit 125 computes the length thereof.

The control circuit 125 computes heat interference amount from the length A of the above-mentioned first mark and length B from the second mark (step S3). With the present embodiment, A-B is computed as the heat interference amount. FIG. 6 shows a computation example of the heat interference amount. As shown in the table in FIG. 6, the length B of the second mark appearing immediately following the longest space has virtually no change, but the length A of the first mark appearing immediately following the shortest space changes greatly according to the situation of the heat interference. Of course, as the length A of the first mark immediately following the shortest space becomes longer, the heat interference amount becomes greater. Note that the data of one record of the table in FIG. 6 regarding a certain optical disc is measured in step S1 and computed in step S3.

Note that the sample subjected to measurement in FIG. 6 may be a Blu-ray disc (BD-R), as described next. The substrate thereof has a primary face of polycarbonate on one side, with an outer diameter of 12 cm and an inner diameter of 1.5 cm, whereupon a guide groove in a spiral shape is provided with a depth of 45 μm and a pitch of 0.32 μm. A light-reflective film which is formed on the upper face wherein the guide groove is provided is formed at a thickness of roughly 50 μm by spattering a silver alloy. An organic pigmented film formed on the upper face of the light-reflective film is formed at a thickness of roughly 40 μm by coating with a dye solution of an azoic dye dissolved in a TFP (tetro fluoro propanol) solution by spin-coating, and drying this for 30 minutes at 80° C. The guide groove described above is sufficiently filled with the organic pigmented film, wherein a laser beam can be sufficiently formed. A protective film is formed on the upper face of the organic pigmented film. The protective film is formed at a thickness of roughly 20 μm by spattering a silicon dioxide. A cover layer formed on the upper face of the protective film is formed with two layers of resin layers. First, a UV resin with an elasticity of roughly 35 (MPa) at 25° C. after hardening is coated with a spin coat method onto the upper face of the organic pigmented film and light-cured, whereby a low-elasticity resin layer at a thickness of roughly 25 μm is formed. A UV-cured resin wherein the elasticity is roughly 1700 (MPa) at 25° C. after hardening is coated with a spin coat method onto the upper face of the low-elasticity resin layer at a thickness of roughly 75 μm and light-cured. The heat interference amount thus can be measured with a BD-R thus configured as a sample.

The measurement of the heat interference amount is based on a recording of general data on the above-mentioned BD-R. Using a data decoding circuit 123, a signal when playing back the BD-R whereupon data is recorded is selected as a 2T mark immediately following a 2T space, the length of the 2T mark is counted by the number of clock signals and subjected to length-conversion, whereby the mark length A may be displayed on an oscilloscope. Also, similarly a 2T mark immediately following an 11T space is selected, measured with the same method, subjected to length-conversion, and the mark length B may be displayed on the oscilloscope. The two measurement results and the computation value of the heat interference amount of the calculation results of (A-B) therefrom may also be displayed, and these values are shown in FIG. 6.

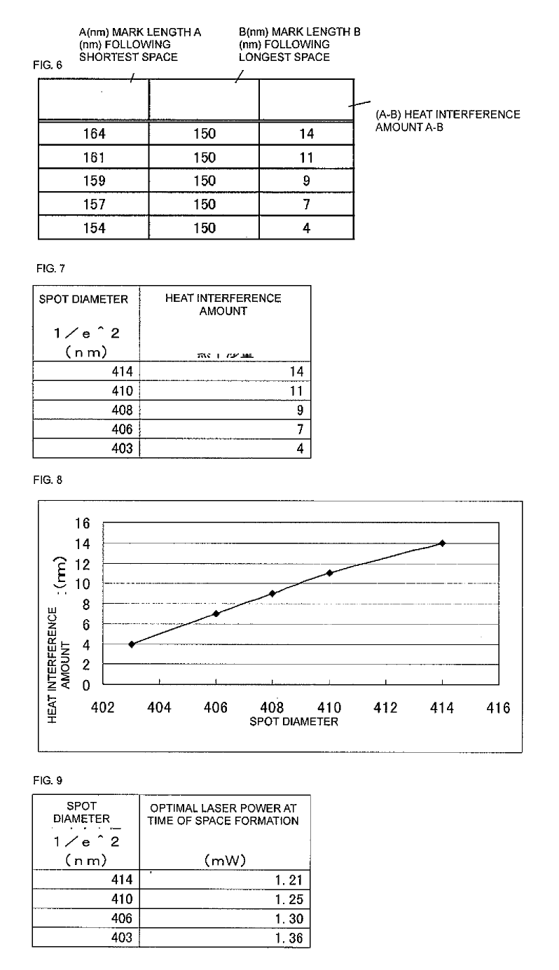

For example in the memory 127, data of measurement results such as those shown in FIG. 7 is stored beforehand, and the control circuit 125 uses the data to specify the spot diameter from the heat interference amount (step S5). The specification of the spot diameter is a value wherein, when measurement of each heat interference amount in FIG. 6 is performed, each spot diameter of the laser beam irradiated from the LD is obtained. That is to say, the spot diameter is a value obtained by finding the diameter with an intensity of 1/e² when the intensity of the center peak is 1 with a spot point image intensity distribution.

Of the device used for the above measurements, a blue-violet LD of approximately 405 nm, and the aperture rate of the objective lens (NA) and RIM value (intensity of the lens edge portions when the center intensity is 1) are approximately 0.85 and approximately 0.65, respectively.

By performing these associations, the spot diameter can be specified from the heat interference amount, which is shown in FIG. 7. Note that the numerical values obtained in FIG. 7 are graphed in FIG. 8. We can also see from the graph in FIG. 8 that the spot diameter becomes great in the case of a large heat interference amount.

Also, data such as that shown in FIG. 9 is stored in the memory 127 for example, and the control circuit 125 specifies the optimal laser power Ps at the time of forming a space from the spot diameter using the data thereof, and sets the LD driver 121 (step S7). The correlation between the spot diameter and the optimal laser power Ps at the time of forming a space in the example in FIG. 9 is selected to be the laser beam spot diameter of 1/e² (nm) which has a high probability of actually being used. The numerical values obtained by matching each spot diameter, matching the conditions when the data in FIG. 6 is obtained, and by changing the laser power Ps (mW) at the time of forming the 2T space of the write strategy to input into the LD driver, are shown in FIG. 9.

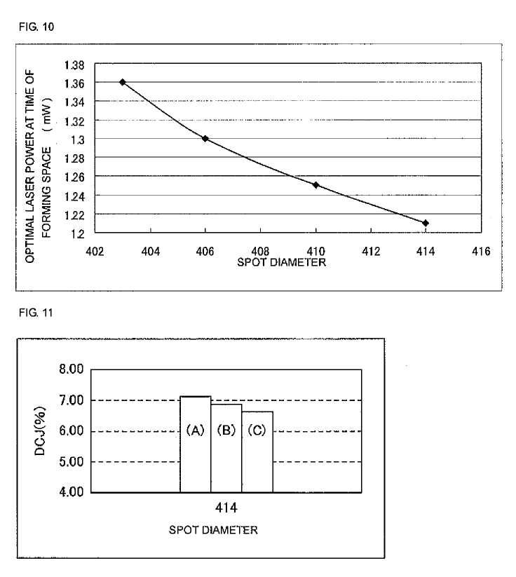

If the spot diameters are specified from numerical values thus obtained which are in a relatively proportional relation, the optimal laser power Ps at the time of forming a space can also be specified. Graphing the data in FIG. 9 results in that of FIG. 10. As we can see from FIG. 10 also, if the spot diameter is small, the optimal laser power Ps at the time of forming a space becomes large, and if the spot diameter is large, the optimal laser power Ps at the time of forming a space becomes small. That is to say, the larger the spot diameter, the smaller the laser power Ps at the time of forming a space becomes; otherwise we can assume that heat interference will occur and evaluation indicators showing the recording quality such as DCJ (Data Clock Jitter) will become poor. Note that in step S7, confirmation is made as to whether the current setting values are in an optimal state, and if in an optimal state the settings are not performed, but if the current setting values are not in an optimal state, resetting is performed.

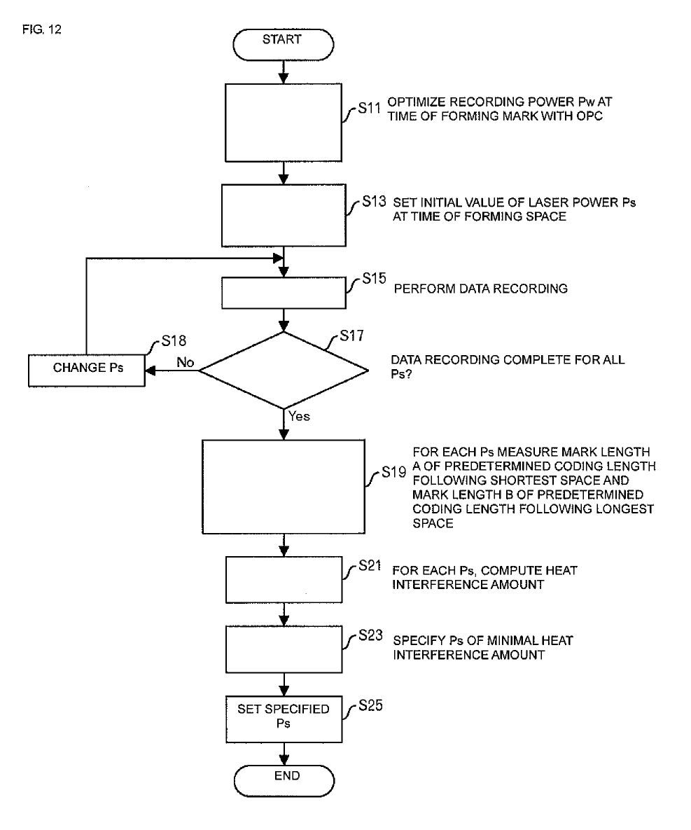

Note that the effects of the processing shown in FIG. 4 are shown in FIG. 11. With FIG. 11, the vertical axis represents DCJ (%), and the horizontal axis represents the spot diameter (414 nm only). With FIG. 11, (A) represents the DCJ in the case of no optimization, (B) indicates the DCJ in the case that the recording power Pw at the time of forming a mark is optimized, and (C) indicates the DCJ in the case that the recording power Pw at the time of forming a mark and the laser power Ps at the time of forming a space are both optimized. Thus, we can see that with the transition from (A) to (C) the DCJ decreases and the recording quality improves. The DCJ in FIG. 11 is measured matching the conditions when obtaining the data in FIG. 6 with the exceptions of fixing the spot diameter to 414 nm, and changing the laser power Pw (mW) at the time of forming a 2T mark and the laser power Ps (mW) when forming a 2T space with the write strategy to input into the LD driver. (A) in the graph is the result of recording by using Pw in FIG. 2 which is optimized such that the DCJ becomes minimal with a spot diameter of 406 nm. (B) is the result of recording by using the Pw which is optimized such that the DCJ becomes minimal with a spot diameter of 414 nm. (C) is the result of recording the Ps in FIG. 2 by using the Pw which is optimized such that the DCJ becomes minimal, in addition to the conditions in (B).

Note that an example is shown wherein measurement during OPC processing is performed in step S1 in FIG. 4, but an arrangement may be made wherein, after optimizing the recording power Pw at the time of forming a mark, test-writing is performed again to perform measurement.

Also, processing is performed wherein the Ps is specified after the spot diameter is specified, but an arrangement may be made wherein, the spot diameter is not specified, and the Ps is directly specified from the heat interference amount.

### Second Embodiment

Next, another method to optimize the laser power Ps at the time of forming a space will be described with reference to FIG. 12. First, the control circuit 125 performs optimization of the recording power Pw at the time of forming a mark with the OPC (step S11), This processing is known in the art, so will not be described further. Note that at this stage, the optimal recording power Pw is set.

Next, the control circuit 125 sets an initial value of the laser power Ps at the time of forming a space in the LD driver 121 (step S13). The control circuit 125 controls the LD driver 121, servo control unit, and so forth, and performs predetermined data recording in a test recording region (step S15). Measurements similar to that of the first embodiment are performed, so the first mark of the predetermined coding length appearing immediately following the shortest space and the second mark which appears immediately following the longest space and which is of the same coding length as the first mark are recorded in the test recording region of the optical disc 150.

The control circuit 125 determines whether the data recording has been completed for all Ps to be set (step S17). For example, the variations of Ps in the event of writing in the test recording region are defined beforehand, and the control circuit 125 determines whether or not data recording has been performed with all of the Ps. In the event that not necessarily all Ps have completed data recording, the control circuit 125 changes to an unset Ps and sets this in the LD driver 121 (step S18). The processing then returns to step S15.

On the other hand, in the case determination is made that data recording has been completed for all Ps, the control circuit 125 controls the LD driver 121, servo control unit, and so forth to play back the data recorded in the test recording region in step S15, and further controls the data decoding circuit 123 to measure the length A of the first mark immediately following the shortest space and the length B of the second mark immediately following the longest space for each Ps (step S19). Measuring is similar to that of the first embodiment. The data decoding circuit 123 outputs the measurement results to the control circuit 125.

The control circuit 125 computes the heat interference amount (A-B) for each Ps (step S21). The control circuit 125 then specifies the Ps of the minimum heat interference amount (step 823), and sets this Ps in the LD driver 121 (step S25).

Thus, a Ps with minimal heat interference amount and which is estimated to be optimal in the range of settable Ps can specified and set, whereby the recording quality can be improved.

### Third Embodiment

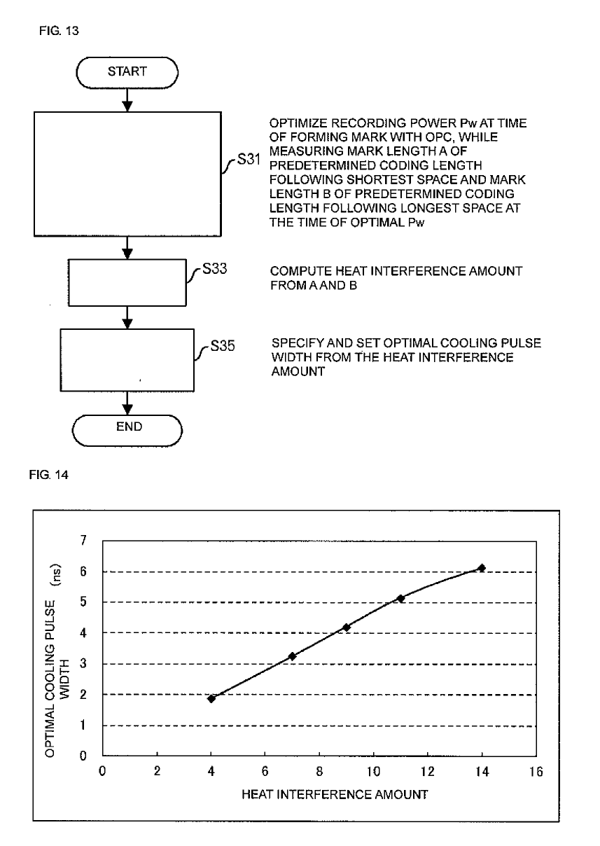

Next, a method to adjust the cooling pulse width will be described with reference to FIGS. 13 and 14.

First, the control circuit 125 performs optimization of the recording power Pw at the time of forming a mark with the OPC, and at the same time causes the data decoding circuit 123 to measure the length A of the first mark of the predetermined coding length which appears immediately following the shortest space when at optimal recording power at the time of forming a mark and the length B of the second mark of the predetermined coding length which appears immediately following the longest space and which is the same coding length as the first mark (step S31 in FIG. 13). Methods of OPC are widely known, so further description thereof will be omitted. When the optimal recording power Pw at the time of forming a mark with the OPC is specified, the length A of the above-mentioned first mark at the time thereof and the length B of the second mark (which may be specified as a time duration or a physical length) are measured. The data decoding circuit 123 outputs the measurement results to the control circuit 125.

The control circuit 125 computes the heat interference amount from the length A of the first mark and the length B of the second mark (step S33). With the present embodiment also, A-B is computed as the heat interference amount. Data of a graph such as that shown in FIG. 14 is stored beforehand in the memory 127 for example, and the control circuit 125 uses this data to specify the optimal cooling pulse width from the heat interference amount, and sets this in the LD driver 121 (step S35). With the example in FIG. 14, the vertical axis represents the optimal cooling pulse width, and the horizontal axis represents the heat interference amount. Thus as the heat interference amount becomes greater the optimal cooling pulse width also becomes longer, and as the heat interference amount becomes smaller the optimal cooling pulse width becomes shorter. Note that in step S35, confirmation is made as to whether the current setting values are in an optimal state, and if in an optimal state, setting is not performed, and if the current setting values are not optimal, setting is performed.

The data in FIG. 14 is the measurement in the event of data signal recording including FIGS. 1A and 1B on the optical disc. Measurement is made with conditions other than these being matched to the conditions when obtaining the data in FIG. 6. With this condition, for each occurrence of heat interference, the cooling pulse power Pc (mW) is changed while the cooling pulse power Pc (mW) which can minimize the DCJ is searched/measured, whereby the values plotted in FIG. 14 are obtained.

Thus, by adjusting the cooling pulse width according to the heat interference amount, recording quality can be improved.

### Fourth Embodiment

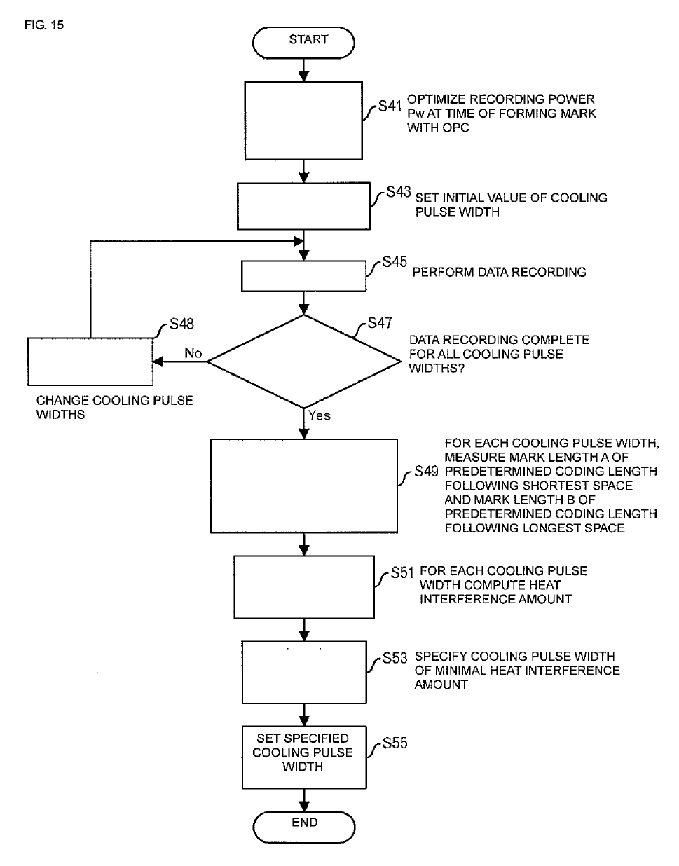

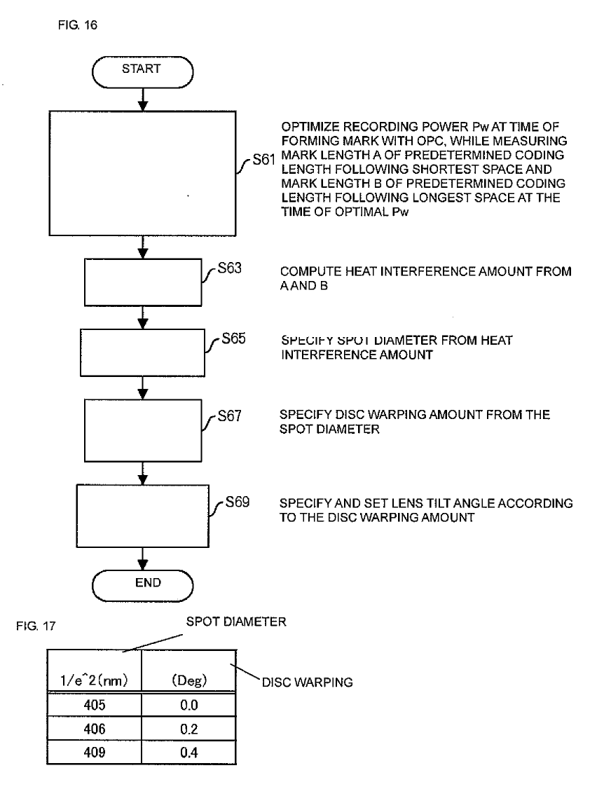

Next, another method to optimize the cooling pulse width will be described with reference to FIG. 15.

First, the control circuit 125 performs optimization of the recording power Pw at the time of forming a mark with the OPC (step S41). This processing is known in the art, so will not be further described. Note that the optimal recording power Pw is to be set in this step.

Next, the control circuit 125 sets an initial value of the cooling pulse width in the LD driver 121 (step S43). The control circuit 125 then controls the LD driver 121, servo control unit and so forth, and performs predetermined data recording in the test recording region (step S45). The measurement performed is similar to that of the first embodiment, so the first mark of the predetermined coding length appearing immediately following the shortest space and the second mark which appears immediately following the longest space and which is the same coding length as the first mark are recorded on the test recording region on the optical disc 150.

The control circuit 125 determines whether the data recording has been completed for all cooling pulse widths to be set (step S47). For example, the variations of cooling pulse widths in the event of writing in the test recording region are defined beforehand, and the control circuit 125 determines whether or not data recording has been performed with all of the cooling pulse widths. In the event that not necessarily all cooling pulse widths have completed data recording, the control circuit 125 changes to an unset cooling pulse width and sets this in the LD driver 121 (step S48). The processing then returns to step S45.

On the other hand, in the case determination is made that data recording has been completed for all cooling pulse widths, the control circuit 125 controls the LD driver 121, servo control unit, and so forth to play back the data recorded in the test recording region in step S45, and further controls the data decoding circuit 123 to measure the length A of the first mark immediately following the shortest space and the length B of the second mark immediately following the longest space for each cooling pulse width (step S49). Measuring is similar to that of the first embodiment. The data decoding circuit 123 outputs the measurement results to the control circuit 125.

The control circuit 125 computes the heat interference amount (A-B) for each cooling pulse width (step S51). The control circuit 125 then specifies the cooling pulse width of the minimum heat interference amount (step S53), and sets this cooling pulse width in the LD driver 121 (step S55).

Thus, a cooling pulse width with minimal heat interference amount and which is estimated to be optimal in the range of settable cooling pulse widths can specified and set, whereby the recording quality can be improved.

### Fifth Embodiment

With the first through fourth embodiments, description is given regarding adjustments to the laser power Ps at the time of forming a space according to the heat interference amount or the cooling pulse width, but with the present embodiment, the tilt angle of the objective lens 114, for example, of the pick-up unit 10 is adjusted.

First, the control circuit 125 performs optimization of the recording power Pw at the time of forming a mark with the OPC, and at the same time causes the data decoding circuit 123 to measure the length A of the first mark of the predetermined coding length which appears immediately following the shortest space when at optimal recording power at the time of forming a mark and the length B of the second mark of the predetermined coding length which appears immediately following the longest space and which is the same coding length as the first mark (step S61 in FIG. 16). Methods of OPC are widely known, so further description thereof will be omitted. When the optimal recording power Pw at the time of forming a mark with the OPC is specified, the length A of the above-mentioned first mark at the time thereof and the length B of the second mark are measured. The length A of the first mark and the length B of the second mark are measured as time or physical length. The data decoding circuit 123 outputs the measurement results to the control circuit 125. Note that an arrangement may be made wherein, in step S61, the data decoding circuit 123 outputs the measured time to the control circuit 125, and the control circuit 125 computes the length thereof

The control circuit 125 computes the heat interference amount from the length A of the first mark and the length B of the second mark (step S63). With the present embodiment, A-B is computed as the heat interference amount. Data such as that shown in FIG. 7 is stored beforehand in the memory 127 for example, and the control circuit 125 uses this data to specify the spot diameter from the heat interference amount (step S65).

Also, data such as that shown in FIG. 17 is stored in the memory 127 for example, and the control circuit 125 uses this data to specify the disc warping amount from the spot diameter (step S67). With the example in FIG. 17, the correlation between the spot diameter and the disc warping amount is stored. Accordingly, if the spot diameter is specified, the disc warping amount can also be specified. As we can see from the data in FIG. 17, if the spot diameter is small, the disc warping amount is small, and if the spot diameter is large, the disc warping amount is also large.

The data in FIG. 17 is selected as a range of spot diameters (nm) of the laser beam having an intensity of 1/e² when standardizing the peak value of a cross-sectional intensity distribution of spots irradiated onto the media to be 1, wherein the cover layer thickness of a disc being recorded onto is 0.1 mm, the numeric aperture of the objective lens is approximately 0.85 (NA), and the laser wavelength is approximately 405 nm, so the warping of the optical disc (Deg) can be simulated on a computer. Thus a representative example of simulation values for warping as to the spot diameters (nm) is listed in FIG. 17.

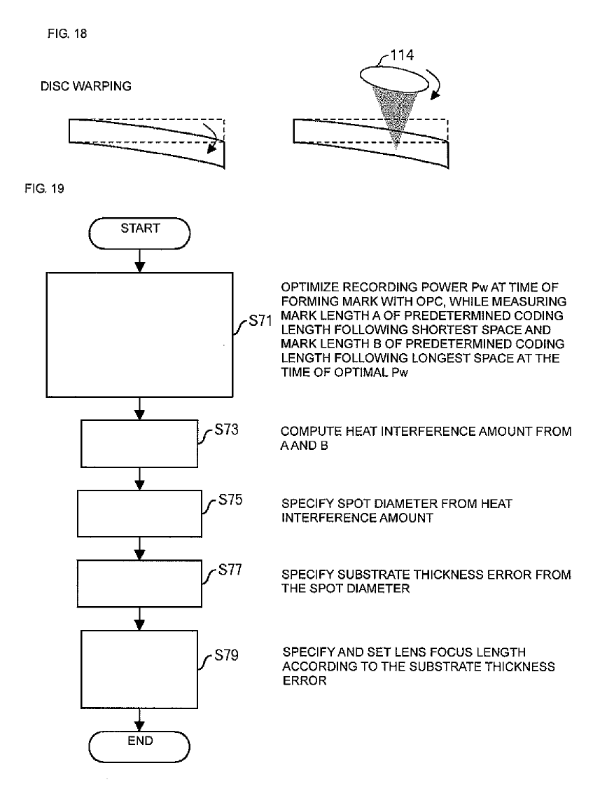

The control circuit 125 specifies a lens tilt angle corresponding to the disc warping amount specified in step S67, based on the correlation data for the disc warping amount and lens tilt angle stored beforehand in the memory 127, and sets the lens tilt angle as to the pick-up unit 110 (step S69). For example, in the case that there is any disc warping as shown on the left side of FIG. 18, the disc warping can be handled by tilting the objective lens 114 for example according to the lens tilt angle specified in step S69, as shown on the right side of FIG. 18, thereby improving recording quality.

Note that in step S69, confirmation is made as to whether the current setting values are in an optimal state, and if in an optimal state no setting is performed, but if the current setting values are not optimal, settings are performed.

Also, in step S61 in FIG. 16 an example is shown wherein measurement is performed during the OPC processing, but an arrangement may be made wherein, after optimizing the recording power Pw at the time of forming a mark, test-writing is performed again to perform the measuring.

Further, processing to specify the disc warping amount is performed after the spot diameter is specified, but an arrangement may be made wherein the disc warping amount is specified directly from the heat interference amount without specifying the spot diameter.

### Sixth Embodiment

With the present embodiment, a method to adjust a lens focus length of the objective lens 114, for example, of the pick-up unit 110 according to the heat interference amount will be described.

First, the control circuit 125 performs optimization of the recording power Pw at the time of forming a mark with the OPC, and at the same time causes the data decoding circuit 123 to measure the length A of the first mark of the predetermined coding length which appears immediately following the shortest space when at optimal recording power at the time of forming a mark and the length B of the second mark of the predetermined coding length which appears immediately following the longest space and which is the same coding length as the first mark (step S71 in FIG. 19). Methods of OPC are known in the art, so further description thereof will be omitted. When the optimal recording power Pw at the time of forming a mark with the OPC is specified, the length A of the above-mentioned first mark at the time thereof and the length B of the second mark are measured. The length A of the first mark and the length B of the second mark are measured as time or physical length. The data decoding circuit 123 outputs the measurement results to the control circuit 125. Note that an arrangement may be made wherein, in step S71 the data decoding circuit 123 outputs the measured time to the control circuit 125, and the control circuit 125 computes the length thereof.

The control circuit 125 computes the heat interference amount from the length A of the first mark and the length B of the second mark (step S73). With the present embodiment, A-B is computed as the heat interference amount. Data such as that shown in FIG. 7 is stored beforehand in the memory 127 for example, and the control circuit 125 uses this data to specify the spot diameter from the heat interference amount (step S75).

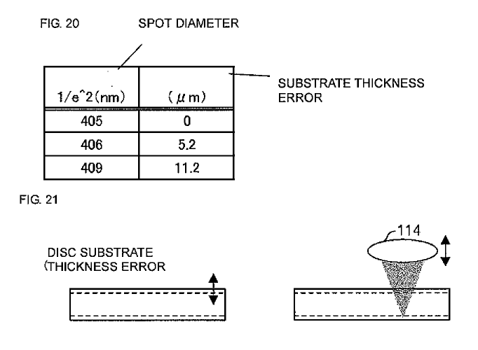

Also, data such as that shown in FIG. 20 is stored in the memory 127 for example, and the control circuit 125 uses this data to specify the substrate thickness error from the spot diameter (step S77). With the example in FIG. 20, the correlation between the spot diameter and the substrate thickness error is stored. Accordingly, if the spot diameter is specified, the substrate thickness error can also be specified. As we can see from the data in FIG. 20, if the spot diameter is small, the substrate thickness error is small, and if the spot diameter is large, the substrate thickness error is also large.

The data in FIG. 20 is obtained similarly as that in FIG. 17. A function is formed from similar conditions, so the substrate thickness error (μm) of the optical disc as to the spot diameter (nm) of the laser beam 1/e² can be simulated on a computer. Thus, a representative example of the simulated values of the substrate thickness error (μm) as to the spot diameter (nm) is listed in FIG. 20.

The control circuit 125 specifies a lens focus length corresponding to the substrate thickness error specified in step S77, based on the correlation data for the substrate thickness error and lens focus length stored beforehand in the memory 127, and sets the lens focus length as to the pick-up unit 110 (step S79). For example, in the case that there is any substrate thickness error on the optical disc 150 as shown on the left side of FIG. 21, the substrate thickness error can be handled by raising/lowering the objective lens 114 for example according to the lens focus length specified in step S79, thereby improving recording quality in accordance with error in substrate thickness error.

Note that in step S79, confirmation is made as to whether the current setting values are in an optimal state, and if in an optimal state no setting is performed, but if the current setting values are not optimal, settings are performed.

Also, in step S71 in FIG. 18 an example is shown wherein measurement is performed during the OPC processing, but an arrangement may be made wherein, after optimizing the recording power Pw at the time of forming a mark, test-writing is performed again to perform the measuring.

Further, processing to specify the substrate thickness error is performed after the spot diameter is specified, but an arrangement may be made wherein the substrate thickness error is specified directly from the heat interference amount without specifying the spot diameter.

### Seventh Embodiment

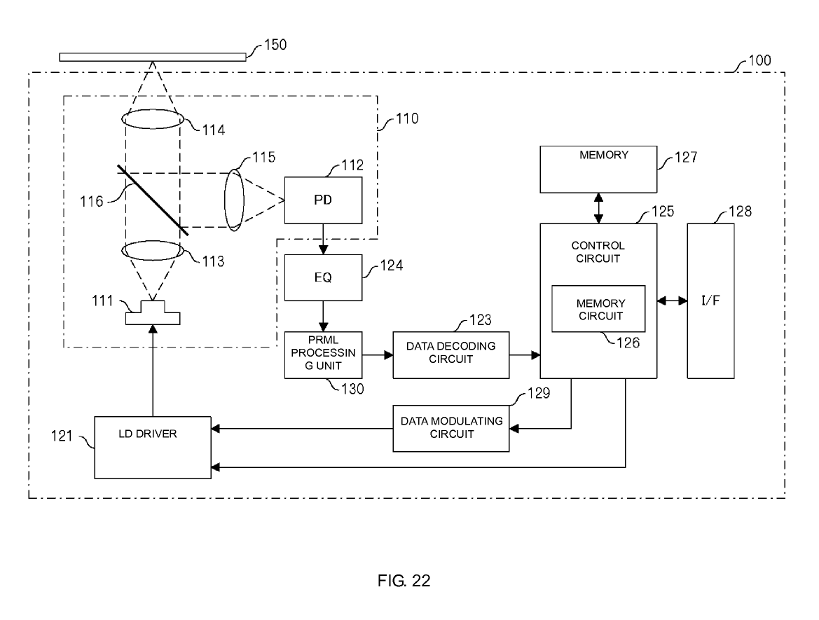

FIG. 3 shows an example wherein PRML (Partial Response Maximum Likelihood) signal processing is not performed, such as with a DVD. On the other hand, in the case of Blu-ray standards or HD-DVD standards, PRML signal processing is used to detect amplitude levels. In such a case, as shown in FIG. 22, a PRML processing unit 130 is introduced instead of the slicer 122. For example with this PRML processing unit 130, an amplitude level A′ corresponding to the first mark of a predetermined coding length which appears immediately following the shortest space and the amplitude level B′ corresponding to the second mark which appears immediately following the longest space and which is of the same coding length as the first mark are measured, and output to the control circuit 125.

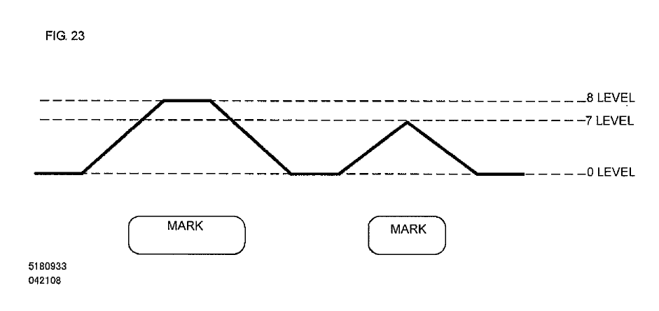

As shown in FIG. 23, the longer the mark the higher the amplitude level becomes, and the shorter the mark the lower the amplitude level becomes. Accordingly, as the heat interference amount increases, the mark length becomes longer whereby the amplitude level becomes higher. Accordingly, by computing A′-B′, the same data as that in the first through sixth embodiments can be obtained.

Embodiments of the present invention have been described above, but the present invention should not be limited to these. For example, the functional block diagrams (FIGS. 3 and 22) are for the purpose of describing embodiments of the present invention, and do not necessarily correspond to actual part configurations.

Also, as long as the processing results do not change, the processing sequence of the processing flow may be interchanged, or processing may be performed concurrently.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A processing method of an optical disc recording/playback signal comprising:
measuring a length of a first mark of a predetermined coding length which appears immediately following a shortest space recorded on the optical disc;
measuring a length of a second mark which appears immediately following a longest space recorded on said optical disc and which has the same coding length as said first mark; and
calculating a heat interference amount based on a difference of the measured length of said first mark and the measured length of said second mark.

2. The processing method of an optical disc recording/playback signal according to claim 1, further comprising setting at least one of a laser power during space forming, a cooling pulse width, an objective lens orientation, and an objective lens position based on said difference between the measured length of the first mark and the measured length of the second mark.

3. The processing method of an optical disc recording/playback signal according to claim 1, further comprising determining a spot diameter of a laser beam irradiating on said optical disc with said calculated heat interference amount.

4. The processing method of an optical disc recording/playback signal according to claim 1, further comprising:
forming the first mark, second mark, shortest space, or longest space using a plurality of data recording conditions;
determining a data recording condition wherein said calculated heat interference amount is minimal; and
setting a recording condition of an optical disc recording/playback device to be substantially equivalent to the determined data recording condition.

5. The processing method of an optical disc recording/playback signal according to claim 1, further comprising determining whether said calculated heat interference amount is appropriate.

6. The processing method of an optical disc recording/playback signal according to claim 1, further comprising determining an optimal laser power at a time of forming a space with said calculated heat interference amount, wherein the determining is based on data comprising a relation between the optimal laser power at the time of forming a space and the heat interference amount.

7. The processing method of an optical disc recording/playback signal according to claim 1, further comprising determining an optimal cooling pulse width with said calculated heat interference amount, wherein the determining is based on data comprising a relation between the optimal cooling pulse width and the heat interference amount.

8. The processing method of an optical disc recording/playback signal according to claim 3, further comprising determining an optimal laser power at the time of forming a space or an optimal cooling pulse width with said calculated heat interference amount, wherein the determining an optimal laser power of the determining an optimal cooling pulse is based on data comprising a relation between the optimal laser power at the time of forming a space or the optimal cooling pulse width and the spot diameter.

9. The processing method of an optical disc recording/playback signal according to claim 4, wherein said data recording condition is a laser power at the time of forming a space or a cooling pulse width.

10. An optical disc recording/playback device comprising:
a measuring unit configured to measure a length of a first mark of a predetermined coding length which appears immediately following a shortest space recorded on the optical disc, and to measure a length of a second mark which appears immediately following a longest space recorded on said optical disc and which has the same coding length of said first mark; and
a computing unit configured to calculate a heat interference amount based on a difference of the measured length of said first mark and the measured length of said second mark.

11. An optical disc recording/playback device according to claim 10, further including a spot diameter unit configured to determine a spot diameter of a laser irradiating said optical disc with said calculated heat interference amount, wherein the spot diameter unit is configured to determine the spot diameter based on data comprising a relation between the spot diameter of the laser irradiating the optical disc and the heat interference amount.

12. An optical disc recording/playback device according to claim 10, further comprising:
a forming unit configured to form the first mark, second mark, shortest space, or longest space using a plurality of data recording conditions,
a determining unit configured to determine a data recording condition wherein said calculated heat interference amount becomes minimal; and
a setting unit configured to set a recording condition of the device to be substantially equivalent to the determined data recording condition.

13. An optical disc recording/playback device according to claim 10, further comprising a interference unit configured to determine whether said calculated heat interference amount is appropriate.

14. The optical disc recording/playback device according to claim 10, further comprising a laser power unit configured to determine an optimal laser power at a time of forming a space with said calculated heat interference amount, wherein the laser power unit is configured to determine an optimal laser power based on data comprising a relation between the optimal laser power at the time of forming a space and the heat interference amount.

15. The optical disc recording/playback device according to claim 10, further comprising a cooling pulse unit configured to determine an optimal cooling pulse width with said calculated heat interference amount, wherein the cooling pulse unit is configured to determine an optimal cooling pulse width based on data comprising a relation between the optimal cooling pulse width and the heat interference amount.

16. The optical disc recording/playback device according to claim 11, further comprising an optimizing unit configured to specify an optimal laser power at the time of forming a space or an optimal cooling pulse width corresponding to said calculated heat interference amount, wherein the optimizing unit is configured to specify an optimal laser power or an optimal cooling pulse width based on data comprising a relation between the optimal laser power at the time of forming a space or the optimal cooling pulse width and the spot diameter, wherein the data has been measured beforehand.

17. The optical disc recording/playback device according to claim 12, wherein said data recording condition is a laser power at the time of forming a space or a cooling pulse width.

18. A computer readable medium having stored therein a program to cause a processor to execute:
measuring a length of a first mark of a predetermined coding length which appears immediately following a shortest space recorded on the optical disc;
measuring a length of a second mark which appears immediately following a longest space recorded on said optical disc and which has the same coding length of said first mark; and
calculating a heat interference amount based on a difference of the measured length of said first mark and the measured length of said second mark.

19. The computer readable medium having stored therein a program according to claim 18, further causing a processor to execute:
forming the first mark, second mark, shortest space, or longest space using a plurality of data recording conditions;
determining a data recording condition wherein said calculated heat interference amount is minimal; and
setting a recording condition of a disc recording/playback device to be substantially equivalent to the determined data recording condition.

20. The computer readable medium having stored therein a program according to claim 18, further causing a processor to determine an optimal laser power at a time of forming a space with said calculated heat interference amount, wherein the optimal laser power is determined based on data comprising a relation between the optimal laser power at the time of forming a space and the heat interference amount, and wherein the data has been measured beforehand.

21. The computer readable medium having stored therein a program according to claim 18, further causing a processor to determine an optimal cooling pulse width with said calculated heat interference amount, wherein the optimal cooling pulse width is determined based on data comprising a relation between the optimal cooling pulse width and the heat interference amount, wherein the data has been measured beforehand.
